(19) United States
(12) Patent Application Publication
(10) Pub. No.: US 2025/0103066 A1
(43) Pub. Date: Mar. 27, 2025

(54) METHOD FOR CONTROLLING A ROTATING SHAFT BY BREAKDOWN OF MEASUREMENTS OF SAID SHAFT INTO STATIONARY AND DISTURBANCE COMPONENTS

(71) Applicant: SKF Magnetic Mechatronics, Saint-Marcel (FR)

(72) Inventors: Pierre BORNERT, Vernon (FR); Joël MOUTERDE, Blaru (FR); Joaquim DA SILVA, Sennely (FR)

(21) Appl. No.: 18/888,629

(22) Filed: Sep. 18, 2024

(30) Foreign Application Priority Data
Sep. 25, 2023 (FR) 2310161

(51) Int. Cl. G05D 3/20; G01M 13/02

(52) U.S. Cl. CPC G05D 3/20; G01M 13/02

(57) ABSTRACT

A method for controlling a rotating shaft by breakdown of measurements of said shaft into stationary and disturbance components. The method for controlling a rotating shaft comprises acquisition of a signal to be filtered (step 160); filtering and breakdown of the signal to be filtered into a stationary component and a disturbance component for each time-frequency pairing of the signal to be filtered (step 170); comparison of the stationary component with respect to a setpoint for each time-frequency pairing (step 190); comparison of the disturbance component with respect to said setpoint for each time-frequency pairing (step 200); and generation of a command of an actuator associated with said shaft such that the actuator modifies a rotation and/or positioning parameter of the rotating shaft (step 210).

### CROSS-REFERENCE TO RELATED APPLICATION

This application claims priority to French Application No. 2310161, filed Sep. 25, 2023, the entirety of which is hereby incorporated by reference.

### FIELD

The present disclosure relates to the characterisation of a shaft rotating about an axis of rotation with a view to correction of the movement and of the position of said rotating shaft.

The present disclosure relates more particularly to the correction, in other words the control, notably by a corrector automatically, of the rotation of a rotating shaft by revealing and using stationary components.

### BACKGROUND

A rotating system, such as a rotating shaft, perfectly balanced, rotates about an axis of rotation such that said axis of rotation is immobile with respect to its theoretical positioning, and therefore with respect to the environment close to the rotating shaft.

However, defects, deformations, gyroscopic effects, or even effects due to the force of gravity can induce an offsetting of the axis of rotation with respect to its theoretical position during the rotation of said rotating shaft. Such is the case for example of deformations of the rotating shaft by virtue of flexible eigenmodes, these modes deforming the shaft as a function of the speed of rotation of said shaft.

When such defects are present, the axis of rotation is not immobile and vibrates. It moves away from its theoretical position on a particular trajectory. More specifically, each point of the axis of rotation can move away from its theoretical position, two points of the axis of rotation at two different ends of the shaft being able to have a different trajectory.

The properties of a rotating shaft are conventionally learned by a lateral analysis of parameters. The parameters are values of radial quantities such as the radial position or speed of the shaft, having a non-zero component in a plane orthogonal to the axis of rotation.

It is often necessary to characterise the changes to these quantities depending on whether or not the axis is rotating. However, multiple causes can influence the rotational behaviour of a rotating shaft and it is complex to specifically characterise such a behaviour using reliable indicators in order to correct said behaviour.

### SUMMARY

The aim of the present disclosure is therefore to mitigate the above-mentioned drawbacks and to propose a simple and fine correction of the rotation of a rotating shaft.

The subject of the present disclosure is a method for controlling a rotating shaft, characterised in that it comprises the following steps:
acquisition of a signal to be filtered determined on the basis of measurements representative of the movement of the rotating shaft, the measurements, linked to a vectorial quantity, being non-collinear with one another and, optionally, coplanar with a plane secant to the axis of rotation of the rotating shaft;
filtering and breakdown of the signal to be filtered into a stationary component and a disturbance component for each time-frequency pairing of the signal to be filtered;
comparison of the stationary component with respect to a setpoint for each time-frequency pairing;
comparison of the disturbance component with respect to said setpoint for each time-frequency pairing; and
generation of a command for an actuator associated with said shaft based on the two comparisons of the stationary and disturbance components, such that the actuator modifies a rotation and/or positioning parameter of the rotating shaft.

Thus, the actuators are used to correct, in other words control or servocontrol, the movement of the shaft finely, stationary component by stationary component, some of them sometimes not requiring any correction and therefore minimising the use of the actuator. In addition, the acquisition of at least one signal to be filtered makes it possible to characterise the rotation of the rotating shaft and to correct the movement if necessary.

In one implementation, the method comprises a step of identification of a model based on the stationary component, the identified model being a frequency and/or parametric model.

Advantageously, the steps of comparison of the stationary and disturbance components are performed with the model identified during the identification step being taken into account.

In a particular mode of implementation, the step of generation of a command for an actuator is performed so as to minimise a difference between the identified model and the stationary and disturbance components.

Advantageously, the filtering and breakdown step comprises a step of generation of stationarity break information.

In one mode of implementation, the method comprises a step of monitoring of the stationarity break information and of generation generating an alert signal when a stationarity break is detected.

Advantageously, the monitoring step is performed with the model identified during the identification step taken into account so as to interpret the stationarity breaks detected.

Advantageously, the steps of comparison, in other words of control, of the stationary and disturbance components are performed with the alert signal generated during the monitoring step taken into account.

In one mode of implementation, the filtering step is performed by application of a filtering template to the signal to be filtered, the filtering template being determined as a function of a characterisation indicator obtained from the following steps:
a) acquisition over a predetermined period of at least two input signals, the input signals comprising measurements representative of the movement of the rotating shaft, the measurements, linked to a vectorial quantity, being non-collinear with one another and, optionally, coplanar with a plane secant to the axis of rotation of the shaft;
b) determination of two components of the input signals, the components being orthogonal to one another and, optionally, to the axis of rotation;
c) merging of the two components into a bivariate signal forming said signal to be filtered;
d) time-frequency breakdown of the bivariate signal into spectral elements;
e) determination of an equivalent ellipse for each spectral element; and
f) extraction of the characterisation indicator of the rotating shaft based on parameters of the equivalent ellipse.

Advantageously, the filtering template is applied to the time-frequency breakdown of the bivariate signal as signal to be filtered so as to obtain the stationary component, the complement of the stationary component being the disturbance component.

### BRIEF DESCRIPTION OF THE DRAWINGS

FIG. 1 is a schematic representation of different steps of obtaining a characterisation indicator of a rotating shaft;

FIG. 2 is a representation of an example of an equivalent ellipse and its Euler parameters as determined in the steps illustrated in FIG. 1;

FIG. 3 is a schematic representation of different filtering steps applicable to a signal to be filtered following the steps of FIG. 1; and

FIG. 4 is a schematic representation of the different steps of the method for controlling a shaft according to the present disclosure.

### DETAILED DESCRIPTION

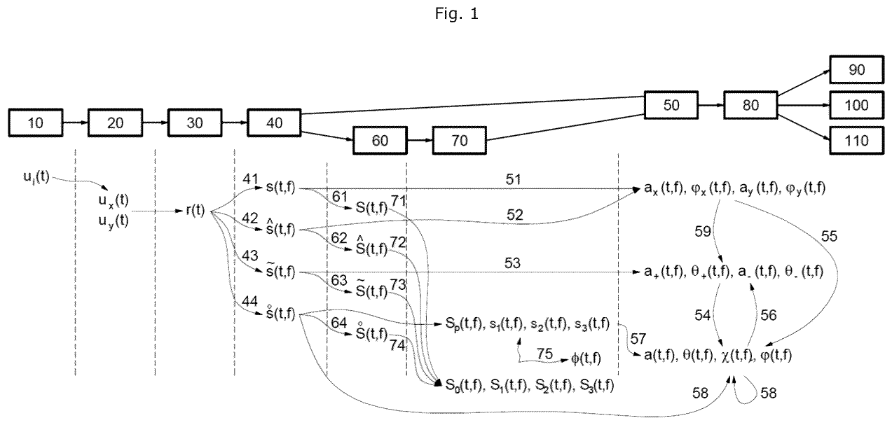

Schematically represented in FIG. 1 are different steps of a method for obtaining an indicator that can, in a particular mode of implementation, be incorporated in the method according to the present disclosure.

These steps make it possible to characterise the behaviour of a rotating shaft. A rotating shaft is understood to be a shaft that is mobile in rotation about an axis of rotation. The rotating shaft is, for example, a shaft of a rotating machine.

For the implementation of the method, a step 10 of acquisition of input signals is performed first.

At least two input signals are acquired over a predetermined period. The predetermined period is for example several seconds.

The input signals comprise measurements representative of the movement of the rotating shaft. For example, the input signals comprise measurements of position, or of speed, or of acceleration, or of force, or of magnetic field, or even of magnetic induction of the rotating shaft. The acquisition of the input signals is performed for example using sensors configured to measure these quantities.

Generally, a vectorial quantity is measured according to a number of components distributed in space that are sensitive to the rotation of the shaft. The distribution in space of these components makes it possible to evaluate the movement of the rotor.

One particular case is that of measurements that are non-collinear with one another and coplanar with a plane secant to the axis of rotation of the shaft. From two non-collinear measurements, a characterisation of the behaviour of the rotating shaft is possible in a plane secant to the axis of rotation of the shaft. Additional measurements allow for a greater accuracy of said characterisation.

Measurements that are non-coplanar with a plane secant to the axis of rotation of the shaft can nevertheless be brought by projection into a reference plane secant to the axis of rotation of the shaft.

For M measurements with M≥2, M input signals u₁(t) to u_{M}(t) are obtained, t designating the time during the acquisition of the measurements, the set of values of which is designated by T, in other words dates, that t can take.

A secant plane is understood to be a plane in which the measurements which cut the axis of rotation of the rotating shaft are made. The secant plane is for example orthogonal to the axis of rotation or non-orthogonal.

In the case where the secant plane is not orthogonal to the axis of rotation, a step 20 of determination of two components of the input signals is performed, the components being orthogonal to one another and to the axis of rotation. In other words, this step 20 is a change of basis facilitating the rest of the calculations.

In the case where the secant plane is orthogonal to the axis of rotation, the preceding step is intrinsically performed.

In the case where the axis of rotation is not strictly and accurately defined, the shaft not always being perfectly cylindrical and/or balanced, and/or not deformable and/or known, said orthogonal secant plane is comparable to a study plane that is assumed orthogonal to the axis of rotation, or at least sensitive to the rotation movement of the shaft.

In practice, the step 20 of determination of the two orthogonal components uₓ (t) and u_{y} (t) is performed by averaging projections of the input signals u₁ (t) to u_{M} (t) on two orthogonal axes x and y, these two axes being ideally orthogonal to the axis of rotation. Thus,

$$∀ t ∈ T , \begin{matrix}{u}_{x} ( t ) = a {v}_{i = [ 1 , M ]} ( {Proj}_{x} ( {u}_{i} ( t ) ) ) \\ {u}_{y} ( t ) = a {v}_{i = [ 1 , M ]} ( {Proj}_{y} ( {u}_{i} ( t ) ) )\end{matrix}$$

The components uₓ (t) and u_{y} (t) are therefore now in the study plane, ideally orthogonal to the axis of rotation.

Then, a step 30 of merging of the two orthogonal components uₓ (t) and u_{y} (t) into one bivariate signal r(t) is performed in order to combine these two components equivalently in the form of a complex signal, such that:

$$∀ t ∈ T , r ( t ) = {u}_{x} ( t ) + 1 i . {u}_{y} ( t )$$

It can also be expressed as follows:

$$r ( t ) = \{ {u}_{x} ( t ) , {u}_{y} ( t ) \}$$

Or even in vectorial form:

$$r ( t ) = [ \begin{matrix}{u}_{x} ( t ) \\ {u}_{y} ( t )\end{matrix} ]$$

A step 40 of frequency breakdown of the bivariate signal r(t) into spectral elements characterised by their time-frequency pairing (t, f), otherwise also called time-frequency cells, is then performed, and this is done periodically in order to obtain a breakdown both in time and in frequency s(t, f) such that:

$$s ( t , f ) = {spectrum}_{t , f} ( r ( τ ) )$$

There are different ways of performing this time-frequency breakdown step 40. These different modes of implementation are presented hereinbelow, the time-frequency breakdowns s, or ŝ, or \tilde{s}, or s̊ being given in continuous form, in other words analogue and non-discrete. A digital implementation implemented by computer then comprises a time and frequency sampling step.

In a first mode of implementation, denoted 41 in FIG. 1, the time-frequency breakdown step 40 is performed with a filter bank around each frequency f.

Thus, the time-frequency breakdown s(t, f) is expressed:

$$∀ f ∈ {F}_{+} , ∀ t ∈ T , s ( t , f ) = r ( t ) * {h}_{f} ( t )$$

with h_{f} the impulse response of a bandpass filter centred around the frequency f, F₊ being all of the frequencies greater than or equal to 0.

In a second mode of implementation 42, the time-frequency breakdown step 40 is performed by Fourier transform, in particular short-term single-sided Fourier transform.

Basically, the time-frequency breakdown is expressed:

$$∀ f \geq 0 , \begin{matrix}{\hat{s}}_{x} ( t , f ) = \frac{1}{d t} . {\int }_{t - df}^{t} {u}_{x} ( τ ) . {e}^{- 1 i \text{.2} π . f . τ} . d τ \\ {\hat{s}}_{y} ( t , f ) = \frac{1}{d t} . {\int }_{t - df}^{t} {u}_{y} ( τ ) . {e}^{- 1 i \text{.2} π . f . τ} . d τ\end{matrix}$$

In practice, more powerful estimators are used that rely on a subdivision into timeslots, with time weightings, averaging over several timeslots, overlaps between successive slots. The formulation is then:

$$∀ τ ∈ {T}_{↓} , ∀ f ∈ {F}_{+} , \begin{matrix}{\hat{s}}_{{x}_{k}} ( t , f ) = {\int }_{t - {dt}_{k}^{-}}^{t + {dt}_{k}^{+}} {u}_{x} ( τ ) . {w}_{k} ( τ - t ) . {e}^{- 1 i \text{.2} π . f . τ} . d τ \\ {\hat{s}}_{{y}_{k}} ( t , f ) = {\int }_{t - {dt}_{k}^{-}}^{t + {dt}_{k}^{+}} {u}_{y} ( τ ) . {w}_{k} ( τ - t ) . {e}^{- 1 i \text{.2} π . f . τ} . d τ\end{matrix}$$

$$∀ τ ∈ {T}_{↓} , ∀ f ∈ {F}_{+} , \begin{matrix}{\hat{s}}_{x} ( t , f ) = a {v}_{k = [ 1 , p ]} ( \frac{{\hat{s}}_{{x}_{k}} ( t , f )}{{w}_{k}^{( 1 )}} ) \\ {\hat{s}}_{y} ( t , f ) = a {v}_{k = [ 1 , p ]} ( \frac{{\hat{s}}_{{y}_{k}} ( t , f )}{{w}_{k}^{( 1 )}} )\end{matrix}$$

With dtₖ⁻ and dtₖ⁺ for k=[1,p] defining a breakdown into p slots, with possible overlap, around a given date t. Conventionally, the breakdown does not depend on t, which is identical for each cell. The temporal extent of the slot k is dtₖ=dtₖ⁻+dtₖ⁺.

The overall temporal extent of the corresponding cell (t,f) is:

$$\begin{matrix}d {t}^{+} = {max}_{k = [ 1 , p ]} ( d {t}_{k}^{+} ) \\ d {t}^{-} = {max}_{k = [ 1 , p ]} ( d {t}_{k}^{-} ) \\ dt = d {t}^{-} + d {t}^{+}\end{matrix}$$

And wₖ(τ) for τ∈[−dtₖ⁻, dtₖ⁺] for k=[1,p] defining a time weighting window for each of these slots, for example of Hanning type. Conventionally, wₖ does not depend on k, which is identical to each slot.

Depending on the spectral quantity estimated, it is necessary to introduce the following compensations:

$$∀ k ∈ [ 1 , p ] , \begin{matrix}{w}_{k}^{( 1 )} = {\int }_{t - {dt}_{k}^{-}}^{t + {dt}_{k}^{+}} {w}_{k} ( τ ) . d τ \\ {w}_{k}^{( 2 )} = {\int }_{t - {dt}_{k}^{-}}^{t + {dt}_{k}^{+}} {w}_{k}^{2} ( τ ) . d τ\end{matrix} ∀ k ∈ [ 1 , p ] , \begin{matrix}{w}_{k}^{( 1 )} = {\int }_{- {dt}_{k}^{-}}^{{dt}_{k}^{+}} {w}_{k} ( τ ) . d τ \\ {w}_{k}^{( 2 )} = {\int }_{- {dt}_{k}^{-}}^{{dt}_{k}^{+}} {w}_{k}^{2} ( τ ) . d τ\end{matrix}$$

In a particular case, the absence of weighting corresponds to wₖ=1, in which case wₖ⁽¹⁾=wₖ⁽²⁾=dtₖ.

In addition, a subset of dates is introduced: T_{↓}={t′ᵢ, i=[1, m′]}

In a third mode of implementation 43, the time-frequency breakdown step 40 is performed by Fourier transform, in particular short-term double-sided Fourier transform, also called “Full-spectrum”, in other words for a set F of frequencies taking values from all of the real numbers.

Thus, the time-frequency breakdown \tilde{s}(t, f) is expressed:

$$∀ f ∈ R , \tilde{s} ( t , f ) = \frac{1}{d t} . {\int }_{t - dt}^{t} r ( τ ) . {e}^{- 1 i \text{.2} π . f . τ} . d τ$$

Or, with a breakdown into temporal blocks:

$$\begin{matrix}∀ t ∈ {T}_{↓} , ∀ f ∈ F , {\tilde{s}}_{k} ( t , f ) = {\int }_{t - {dt}_{k}^{-}}^{t + {dt}_{k}^{+}} r ( τ ) . {w}_{k} ( τ - t ) . {e}^{- 1 i \text{.2} π . f . τ} . d τ \\ ∀ t ∈ {T}_{↓} , ∀ f ∈ F , \tilde{s} ( t , f ) = a {v}_{k = [ 1 , p ]} ( \frac{{\tilde{s}}_{k} ( t , f )}{{w}_{k}^{( 1 )}} )\end{matrix}$$

In a fourth mode of implementation 44, the time-frequency breakdown step 40 is performed by Fourier transform, in particular short-term quaternion Fourier transform, involving unitary imaginary numbers verifying 1i²=1j²=1k²=1i·1j·1k=−1.

Thus, basically the time-frequency breakdown s̊(t, f) is expressed:

$$∀ f \geq 0 , {s}^{o} ( t , f ) = \frac{1}{dt} . {\int }_{t - dt}^{t} r ( τ ) . {e}^{- 1 j \text{.2} π . f . τ} . d τ$$

Or with a breakdown into temporal blocks:

$$\begin{matrix}∀ t ∈ {T}_{↓} , ∀ f ∈ {F}_{+} , {{s}_{k}}^{o} ( t , f ) = {\int }_{t - {dt}_{k}^{-}}^{t + {dt}_{k}^{+}} r ( τ ) . {w}_{k} ( τ - t ) . {e}^{- 1 i \text{.2} π . f . τ} . d τ \\ ∀ t ∈ {T}_{↓} , ∀ f ∈ {F}_{+} , {s}^{o} ( t , f ) = {av}_{k = [ 1 , p ]} ( \frac{{{s}_{k}}^{o} ( t , f )}{{w}_{k}^{( 1 )}} )\end{matrix}$$

The expressions of the Fourier transforms given in the modes of implementation 41 to 44 above constitute applicable formulae, producing powerful estimators notably in their formulation with temporal weightings, averaging over several timeslots, overlaps between successive slots, for which a more general expression can be given:

$$\overbrace{{s}_{k}} ( t , f ) = \frac{1}{{dt}_{k}} . {\int }_{t - {dt}_{k}^{-}}^{t + {dt}_{k}^{+}} r ( τ ) . {w}_{k} ( τ ) . {e}^{- 1 μ \text{.2} π . f . τ} . d τ$$

wₖ being the temporal weighting, and μ being defined such that 1μ²=−1.

Finally,

$$\overbrace{s} ( t , f ) = {av}_{k} ( \overbrace{{s}_{k}} ( t , f ) )$$

The index k applied to wₖ (above) or pₖ (below) means that the weighting can differ from one slot to another.

Furthermore, other frequency transforms can be used, such as wavelet breakdowns.

A more general expression is:

$$\overbrace{{s}_{k}} ( t , f ) = {\int }_{t - {dt}_{k}^{-}}^{t + {dt}_{k}^{+}} r ( τ ) . {p}_{k} ( τ , f ) . d τ$$

Even more generally, it is possible to vary the temporal breakdown and the weighting as a function of the time-frequency cell (t, f):

$$\overbrace{{s}_{k}} ( t , f ) = {\int }_{t - {dt}_{k}^{-} ( t , f )}^{t + {dt}_{k}^{+} ( t , f )} r ( τ ) . {p}_{k} ( t , f ) ( τ ) . d τ$$

The trajectory (orbit) is obtained by inverse transformation, of type:

$$s ( t , f ) ( τ ) = {\int }_{f - {df}^{-} ( t , f )}^{f + {df}^{+} ( t , f )} ( \overbrace{s} ( t , v ) . q ( t , f ) ( τ , v ) + \overbrace{s} ( t , - v ) . q ( t , f ) ( τ , - v ) ) . dv$$

The frequency extent of the cell (t, f) being then df=df⁺+df⁻, the temporal extent of the cell (t, f) being dt=dt⁺+dt⁻.

From each spectral element s(t, f), at a date t and a frequency f that are fixed, it is possible to deduce the instantaneous orbit of an equivalent ellipse. It can be qualified as local in the time and frequency sense, in other words at the date t and at the frequency f.

A step 50 of determination of the equivalent ellipse is then performed for each spectral element. Whatever the time-frequency breakdown method, the instantaneous orbit can be expressed in the form of a parametric equation such that, for each component x and y, and with sₓ_{ₒ}, s_{y}_{ₒ}, and Øₓ, Ø_{y} the instantaneous amplitudes and phases:

$$\begin{matrix}{s}_{x} ( t , f ) = {s}_{{x}_{o}} ( t , f ) . cos ( {∅}_{x} ( t , f ) ) \\ {s}_{y} ( t , f ) = {s}_{{y}_{0}} ( t , f ) . cos ( {∅}_{y} ( t , f ) )\end{matrix}$$

For a frequency f that is fixed, covering the time t makes it possible to obtain the trajectory at this frequency.

This instantaneous orbit takes the form of an equivalent ellipse, as long as sₓ(t, f), s_{y}(t, f)), \dot{Ø}ₓ(t, f), \dot{Ø}_{y}(t, f) vary slowly as a function of time, for example during a complete revolution at the frequency f, and in all cases during the time dt of the timeslot defining the spectral element.

In this case, the date t of the spectral element considered can be distinguished from the time τ which changes in this spectral element and, by introducing the frequency f into the expression of the assumed quasi-linear phases, the equivalent ellipse is obtained in temporal parametric equation form for each component x and y:

$$\begin{matrix}{ś}_{x} ( t , f ) ( τ ) = {a}_{x} ( t , f ) . cos ( 2 . π . f . τ + {φ}_{x} ( t , f ) ) \\ {ś}_{y} ( t , f ) ( τ ) = {a}_{y} ( t , f ) . cos ( 2. π . f . τ + {φ}_{y} ( t , f ) )\end{matrix}$$

Another way of writing these parametric equations is for example:

$$\begin{matrix}{ś}_{x} ( t , f ) ( τ ) = {a}_{x} ( t , f ) . ( c o s ( 2 . π . f . τ ) . cos ( {φ}_{x} ( t , f ) ) - sin ( 2 . π . f . τ ) . sin ( {φ}_{x} ( t , f ) ) ) \\ {ś}_{y} ( t , f ) ( τ ) = {a}_{y} ( t , f ) . ( c o s ( 2 . π . f . τ ) . cos ( {φ}_{y} ( t , f ) ) - sin ( 2 . π . f . τ ) . sin ( {φ}_{y} ( t , f ) ) )\end{matrix}$$

To obtain these parametric equations, notably in the case of a frequency breakdown by filter bank, the parameters aₓ(t, f), φₓ(t, f), a_{y}(t, f), φ_{y}(t, f) of the equivalent ellipse can be obtained by estimations, such as direct or quadratic averaging or averaging by effective value, based on the instantaneous quantities (τ, f) for τ∈[t−dt⁻, t+dt⁺].

In the case of a frequency breakdown by Fourier transform, the parametric equation of the equivalent ellipse is obtained by inverse Fourier transform of the frequency element:

$$\begin{matrix}{ś}_{x} ( t , f ) ( τ ) = 2. Re ( {\hat{s}}_{x} ( t , f ) . {e}^{1 i \text{.2} π f . τ} ) \\ {ś}_{y} ( t , f ) ( τ ) = 2. Re ( {\hat{s}}_{y} ( t , f ) . {e}^{1 i \text{.2} π . f . τ} )\end{matrix}$$

By forming the associated complex quantity ś(t, f)=śₓ(t, f)+1i·ś_{y}(t, f), in other words the bivariate representation, the breakdown of a parametric equation of the equivalent ellipse into two circles of opposite directions is revealed:

$${s}^{′} ( t , f ) ( τ ) = {a}_{-} ( t , f ) . {e}^{1 i . {θ}_{+} ( t , f )} . {e}^{1 i \text{.2} . π . f . τ} + {a}_{+} ( t , f ) . {e}^{- 1 i . {θ}_{-} ( t , f )} . {e}^{- 1 i \text{.2} . π . f . τ}$$

With the following parameters obtained following a calculation step 59:

$$\begin{matrix}{a}_{+} = \frac{a}{2} \cdot \sqrt{{a}_{x}^{2} + {a}_{y}^{2} + 2. {a}_{x} . sin ( {φ}_{x} - {φ}_{y} )} \\ {a}_{-} = \frac{a}{2} \cdot \sqrt{{a}_{x}^{2} + {a}_{y}^{2} + 2. {a}_{x} . sin ( {φ}_{y} - {φ}_{x} )} \\ {θ}_{+} = arctan 2 ( {a}_{x} . sin ( {φ}_{x} ) + {a}_{y} . cos ( {φ}_{y} ) , {a}_{x} . cos ( {φ}_{x} ) - {a}_{y} . sin ( {φ}_{y} ) ) \\ {θ}_{-} = arctan 2 ( {a}_{x} . sin ( {φ}_{x} ) - {a}_{y} . cos ( {φ}_{y} ) , {a}_{x} . cos ( {φ}_{x} ) + {a}_{y} . sin ( {φ}_{y} ) )\end{matrix}$$

The characterisation of the equivalent ellipse is natural with the double-sided (“full spectrum”) Fourier transform which can directly be written in polar form:

$$∀ f > 0 , \begin{matrix}\tilde{s} ( t , f ) = {a}_{+} ( t , f ) . {e}^{1 i . {θ}_{+} ( t , f )} \\ \tilde{s} ( t , - f ) = {a}_{-} ( t , f ) . {e}^{- 1 i . {θ}_{-} ( t , f )}\end{matrix}$$

Generally, an equivalent ellipse can be determined and plotted by obtaining its Euler parameters.

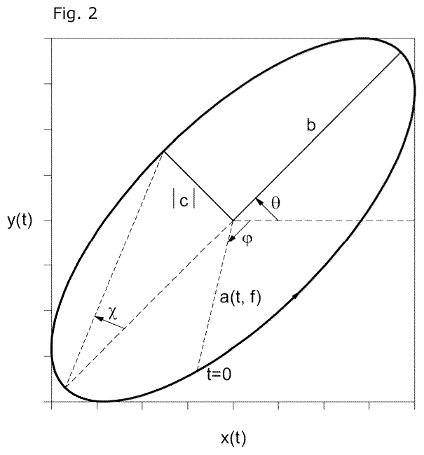

FIG. 2 shows an example of an ellipse and its Euler parameters a(t, f), θ(t, f), χ(t,f), φ(t, f) which fully define an equivalent ellipse, with:

$$\begin{matrix}a \geq 0 \\ θ ∈ [ - π / 2 , π / 2 ] \\ χ ∈ [ - π / 4 , π / 4 ] \\ φ ∈ [ - π , π ]\end{matrix}$$

Moreover, b is the half-large axis, in other words the large radius, and c is the half-minor axis, in other words the minor radius, the sign of which gives the direction of rotation of the equivalent ellipse.

The parametric equation of the trajectory of the equivalent ellipse is easier in complex form, because:
a circle equation is expressed, notably in cos and sin of the same phase,
the axes are made to expand to obtain an ellipse,
a rotation is applied to it to obtain the desired direction, thus:

$$\begin{matrix}{s}^{′} ( t , f ) ( τ ) = a ( t , f ) . {e}^{1 i . θ ( t , f )} . ( cos ( χ ( t , f ) ) . cos ( 2. π . f . τ + φ ( t , f ) ) \\ + 1 i . sin ( χ ( t , f ) ) . sin ( 2. π . f . τ + φ ( t , f ) ) )\end{matrix}$$

Direction is understood to be the angle θ of the equivalent ellipse between the large axis and the axis x. Orientation is understood to mean the direction of rotation describing the trajectory of said ellipse.

This characterisation of the equivalent ellipse is natural with the time-frequency breakdown by quaternion Fourier transform which can directly be set in Euler form:

$${s}^{o} ( t , f ) = \vert {s}^{o} ( t , f ) \vert . {e}^{1 i . θ ( t , f )} . {e}^{- 1 k . χ ( t , f )} . {e}^{1 j . φ ( t , f )}$$

This parametric equation has the particular benefit of rejecting the temporal parameterisation to a single exponential term e^{1j·2·π·f·τ} when the inverse Fourier transform is applied to the frequency element in order to obtain the temporal parametric equation of the trajectory of the equivalent ellipse:

$${s}^{′} ( t , f ) ( τ ) \approx \vert {s}^{o} ( t , f ) \vert . {Proj}_{{⊂}_{1 i}} ( {e}^{1 i . θ ( t , f )} . {e}^{- 1 k . χ ( t , f )} . {e}^{1 j . φ ( t , f )} . {e}^{1 j \text{.2} . π . f . τ} )$$

with Proj_{C}_{₁ᵢ} a projection into the set of the complex numbers C₁ᵢ.

More specifically, the step 50 of determination of the equivalent ellipse comprises a step of calculation of Euler parameters of said equivalent ellipse.

By starting from the time-frequency breakdown by filter bank, a step 51 of calculation of aₓ and a_{y} is obtained such that:

$$∀ t ∈ {T}_{↓} , ∀ f ∈ {F}_{+}^{*} , \begin{matrix}{a}_{x} ( t , f ) = \sqrt{\frac{2}{dt} . {\int }_{t - {dt}^{-}}^{t + {dt}^{+}} {s}_{x}^{2} ( τ , f ) . d τ} \\ {a}_{y} ( t , f ) = \sqrt{\frac{2}{dt} . {\int }_{t - {dt}^{-}}^{t + {dt}^{+}} {s}_{y}^{2} ( τ , f ) . d τ}\end{matrix}$$

T_{↓} being a subset of T.

By starting from the time-frequency breakdown by short-term single-sided Fourier transform, a step 52 of calculation of aₓ, a_{y}, φₓ and φ_{y} is obtained such that:

$$∀ t ∈ {T}_{↓} , ∀ f ∈ {F}_{+}^{*} , \begin{matrix}{a}_{x} ( t , f ) = 2. \vert {\hat{s}}_{x} ( t , f ) \vert {φ}_{x} ( t , f ) = Arg ( {\hat{s}}_{x} ( t , f ) ) \\ {a}_{y} ( t , f ) = 2. \vert {\hat{s}}_{y} ( t , f ) \vert {φ}_{y} ( t , f ) = Arg ( {\hat{s}}_{x} ( t , f ) )\end{matrix}$$

By starting from the time-frequency breakdown by short-term double-sided Fourier transform, a step 53 of calculation of a₊, a₋, θ₊ and θ₋ is obtained such that:

$$∀ t ∈ {T}_{↓} , ∀ f ∈ {F}_{+}^{*} , \begin{matrix}{a}_{+} ( t , f ) = \vert \tilde{s} ( t , f ) \vert {θ}_{+} ( t , f ) = Arg ( \tilde{s} ( t , f ) ) \\ {a}_{-} ( t , f ) = \vert \tilde{s} ( t , - f ) \vert {θ}_{-} ( t , f ) = - Arg ( \tilde{s} ( t , - f ) )\end{matrix}$$

By an additional calculation step 54 or 55, the following Euler parameters are obtained:

$$\begin{matrix}a = \sqrt{2.} \sqrt{{a}_{+}^{2} + {a}_{-}^{2}} \\ φ = \frac{{θ}_{+} + {θ}_{-}}{2} \\ θ = \frac{{θ}_{+} - {θ}_{-}}{2} \\ χ = arctan 2 ( {a}_{+} - {a}_{-} , {a}_{+} + {a}_{-} )\end{matrix} or \begin{matrix}a = \sqrt{{a}_{x}^{2} + {a}_{y}^{2}} \\ φ = \frac{{φ}_{x} + {φ}_{y}}{2} \\ θ = \frac{1}{2} . arctan 2 ( 2. {a}_{x} . {a}_{y} . cos ( {φ}_{x} - {φ}_{y} ) , {a}_{x}^{2} - {a}_{y}^{2} ) \\ χ = \frac{1}{2} . arcsin ( {ratio}^{*} ( 2. {a}_{x} . {a}_{y} , {a}_{x}^{2} + {a}_{y}^{2} ) . sin ( {φ}_{x} - {φ}_{y} ) )\end{matrix}$$

The step 56 of inverse calculation is also possible, such that:

$$\begin{matrix}{a}_{+} = \frac{a}{2} . ( cos ( χ ) + sin ( χ ) ) \\ {a}_{-} = \frac{a}{2} . ( cos ( χ ) - sin ( χ ) ) \\ {θ}_{+} = φ + θ \\ {θ}_{-} = φ - θ\end{matrix}$$

The method optionally comprises a step 60 of calculation of the spectral density of the time-frequency breakdown. The spectral densities of each component and crossed between components make it possible to estimate the energy distribution between the components x and y.

By starting from the time-frequency breakdown by filter bank, a step 61 of calculation of the spectral density S is obtained such that:

$$∀ t ∈ {T}_{↓} , ∀ f ∈ {F}_{+} , \begin{matrix}{S}_{x} ( t , f ) = \frac{1}{d t} . {\int }_{t - {dt}^{-}}^{t + {dt}^{+}} {s}_{x}^{2} ( τ , f ) . d τ \\ {S}_{y} ( t , f ) = \frac{1}{d t} . {\int }_{t - {dt}^{-}}^{t + {dt}^{+}} {s}_{y}^{2} ( τ , f ) . d τ \\ {S}_{x y} ( t , f ) = \frac{1}{d t} . {\int }_{t - {dt}^{-}}^{t + {dt}^{+}} {s}_{x} ( τ , f ) . {s}_{y} ( τ , f ) . d τ\end{matrix}$$

By starting from the time-frequency breakdown by short-term single-sided Fourier transform, a step 62 of calculation of the spectral density Ŝ is obtained such that:

$$∀ t ∈ {T}_{↓} , ∀ f ∈ {F}_{+}^{*} , \begin{matrix}{\hat{S}}_{x} ( t , f ) = 2 . df . a {v}_{k = [ 1 , p ]} ( \frac{{\vert {\hat{s}}_{{x}_{k}} ( t , f ) \vert}^{2}}{{w}_{k}^{( 2 )}} ) \\ {\hat{S}}_{y} ( t , f ) = 2 . df . a {v}_{k = [ 1 , p ]} ( \frac{{\vert {\hat{s}}_{y κ} ( t , f ) \vert}^{2}}{{w}_{k}^{( 2 )}} ) \\ {\hat{S}}_{x y} ( t , f ) = 2 . df . a {v}_{k = [ 1 , p ]} ( \frac{{\hat{s}}_{{x}_{k}} ( t , f ) . \overline{{\hat{s}}_{y κ} ( t , f )}}{{w}_{k}^{( 2 )}} )\end{matrix}$$

By starting from the time-frequency breakdown by short-term double-sided Fourier transform, a step 63 of calculation of the spectral density \tilde{S} is obtained such that:

$$∀ t ∈ {T}_{↓} , ∀ f ∈ {F}_{+}^{*} , {\tilde{S}}_{x} ( t , f ) = df . a {v}_{k = [ 1 , p ]} ( \frac{{\vert {\hat{s}}_{k} ( t , f ) \vert}^{2}}{{w}_{k}^{( 2 )}} )$$

The following will also be used:

$$∀ t ∈ {T}_{↓} , ∀ f ∈ {F}_{+}^{*} , {\tilde{S}}_{*} ( t , f ) = df . {av}_{k = [ 1 , p ]} ( \frac{{\tilde{s}}_{k} ( t , f ) . {\tilde{s}}_{k} ( t , - f )}{{w}_{k}^{( 2 )}} )$$

By starting from the time-frequency breakdown by short-term quaternion Fourier transform, a step 64 of calculation of the spectral density S̊ is obtained such that:

$$∀ t ∈ {T}_{↓} , ∀ f ∈ {F}_{+} , {S}^{o} ( t , f ) = df . {av}_{k = [ 1 , p ]} ( \frac{{\vert {{s}^{o}}_{k} ( t , f ) \vert}^{2}}{{w}_{k}^{( 2 )}} ) + df . {av}_{k = [ 1 , p ]} ( \frac{{{s}^{o}}_{k} ( t , f ) \text{.1} j . \overline{{{s}^{o}}_{k} ( t , f )}}{{w}_{k}^{( 2 )}} )$$

Based on these spectral densities S, Ŝ, \tilde{S}, and S̊, a step 70 of calculation of the Stokes parameters S₀, S₁, S₂, and S₃ of at least one equivalent ellipse is performed.

The Stokes parameters are four real numbers and are conventionally used to describe the state of polarisation of an electromagnetic wave.

S₀ is commonly the total intensity of an electromagnetic wave and here represents by extension the total intensity of the bivariate signal, S₀>0.

S₁ and S₂ give the rectilinear polarisation intensity \sqrt{S₁²+S₂²} and the direction of the polarisation of the ellipse

$$θ = \frac{1}{2} . atan 2 ( {S}_{2} , {S}_{1} ) .$$

S₃ gives the circular polarisation intensity |S₃|, its sign giving the direction of rotation.

The reduced Stokes parameters are also defined:

$$if {S}_{0} \neq 0 , ∀ i ∈ \{ 1 , 2 , 3 \} {s}_{i} {=}^{def} \frac{{S}_{i}}{{S}_{0}}$$

By starting from the spectral density obtained for the time-frequency breakdown by filter bank, a step 71 of calculation of the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2 . ( {S}_{x} ( t , f ) + {S}_{y} ( t , f ) ) \\ {S}_{1} ( t , f ) = 2 . ( {S}_{x} ( t , f ) - {S}_{y} ( t , f ) )\end{matrix}$$

By starting from the spectral density obtained for the time-frequency breakdown by short-term single-sided Fourier transform, a step 72 of calculation of the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2. ( {\hat{S}}_{x} ( t , f ) + {\hat{S}}_{y} ( t , f ) ) \\ {S}_{1} ( t , f ) = 2. ( {\hat{S}}_{x} ( t , f ) - {\hat{S}}_{y} ( t , f ) ) \\ {S}_{2} ( t , f ) = 4. Re ( {\hat{S}}_{x y} ( t , f ) ) \\ {S}_{3} ( t , f ) = 4. Im ( {\hat{S}}_{x y} ( t , f ) )\end{matrix}$$

By starting from the spectral density obtained for the time-frequency breakdown by short-term double-sided Fourier transform, a step 73 of calculation of the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2. ( \tilde{S} ( t , f ) + \hat{S} ( t , - f ) ) \\ {S}_{1} ( t , f ) = 4. Re ( {\tilde{S}}_{*} ( t , f ) ) \\ {S}_{2} ( t , f ) = 4. Im ( {\tilde{S}}_{*} ( t , f ) ) \\ {S}_{3} ( t , f ) = 4. 2. ( \tilde{S} ( t , f ) - \tilde{S} ( t , - f ) )\end{matrix}$$

By starting from the spectral density obtained for the time-frequency breakdown by short-term quaternion Fourier transform, a step 74 of calculation of the Stokes parameters of at least one equivalent ellipse is obtained such that:

$$t ∈ {T}_{↓} , ∀ f ∈ {F}_{+} , \begin{matrix}{S}_{0} ( t , f ) = Re ( {S}^{o} ( t , f ) ) \\ {S}_{1} ( t , f ) = {Im}_{1 j} ( {S}^{o} ( t , f ) ) \\ {S}_{2} ( t , f ) = {Im}_{1 k} ( {S}^{o} ( t , f ) ) \\ {S}_{3} ( t , f ) = {Im}_{1 i} ( {S}^{o} ( t , f ) )\end{matrix}$$

In a variant, the Stokes parameters S₁, S₂, and S₃ are calculated directly using the time-frequency breakdown by quaternion Fourier transform:

$$∀ t ∈ {T}_{↓} , ∀ f ∈ {F}_{+} , \begin{matrix}{σ}^{o} ( t , f ) = {s}^{o} ( t , f ) \text{.1} j . \overline{{s}^{o} ( t , f )} \\ {S}_{1} ( t , f ) = {Im}_{1 j} ( {σ}^{o} ( t , f ) ) \\ {S}_{2} ( t , f ) = {Im}_{1 k} ( {σ}^{o} ( t , f ) ) \\ {S}_{3} ( t , f ) = {Im}_{1 i} ( {σ}^{o} ( t , f ) )\end{matrix}$$

Based on these Stokes parameters, a step 75 of calculation of the polarisation rate Ø and of the reduced Stokes parameters previously mentioned, as well as the polarised part of the intensity Sₚ, is performed.

$$∀ t ∈ {T}_{↓} , ∀ f ∈ {F}_{+} , \begin{matrix}∀ i ∈ \{ 1 , 2 , 3 \} {s}_{i} ( t , f ) = {ratio}^{*} ( {S}_{i} ( t , f ) , {S}_{0} ( t , f ) ) \\ ∅ ( t , f ) = \sqrt{{s}_{1}^{2} ( t , f ) + {s}_{2}^{2} ( t , f ) + {s}_{3}^{2} ( t , f )} \\ {S}_{p} ( t , f ) = ∅ ( t , f ) . {S}_{0} ( t , f )\end{matrix}$$

The polarisation expressed by the polarisation rate Ø makes it possible to highlight the cyclo-stationarity of an equivalent ellipse, namely the regularity of the trajectory of said ellipse with respect to a revolution period. The polarisation reflects the structuring of said trajectory relative to defined frequencies. The polarisation rate can thus be calculated for each time-frequency cell derived from the time-frequency breakdown in order to highlight the cyclo-stationarity of the rotating shaft for a given frequency.

Moreover, a calculation step 57 can be implemented to determine Euler parameters a, θ, and χ from the polarisation spectral density Sₚ and the reduced Stokes parameters:

$$∀ t ∈ {T}_{↓} , ∀ f ∈ {F}_{+}^{*} , \begin{matrix}a ( t , f ) = \sqrt{{S}_{p} ( t , f )} \\ θ ( t , f ) = \frac{1}{2} . arctan 2 ( {s}_{2} ( t , f ) , {s}_{1} ( t , f ) ) \\ χ ( t , f ) = \frac{1}{2} . arcsin ( {ratio}^{*} ( {s}_{3} ( t , f ) , {S}_{p} ( t , f ) )\end{matrix}$$

A fourth Euler parameter φ giving the phase at the origin of the trajectory can also be deduced by the following calculation step 58:

$$∀ t ∈ {T}_{↓} , ∀ f ∈ {F}_{+}^{*} , φ ( t , f ) = Arg ( {Proj}_{{⊂}_{1 j}} ( {e}^{1 k . χ ( t , f )} . {e}^{- 1 i . θ ( t , f )} . {s}^{o} ( t , f ) ) )$$

Following the step 50 of determination of an equivalent ellipse, notably by the calculation of Euler parameters of said equivalent ellipse, a step 80 of extraction of at least one characterisation indicator of the rotating shaft is performed based on parameters of the equivalent ellipse, for example Euler parameters, Stokes parameters or parameters derived therefrom.

Furthermore, the preceding steps are optionally performed at least one second time for an additional plane secant to the axis of rotation of the shaft and distinct from the plane for which these steps have been performed first. In this mode of implementation, it is possible to perform a step of comparison of the characterisation indicators of the planes.

For example, the at least one characterisation indicator comprises the polarisation rate Ø previously described, and/or an indicator of circularity (linked to |χ|), and/or an indicator of intensity and/or an indicator of amplitude, and/or of orientation, and/or an indicator of direction of rotation (linked to the sign of χ), and/or an indicator of direction (linked to θ), and/or of synchronisation (linked to φ) of the equivalent ellipse.

Each elementary indicator contributes to a concrete and useful characteristic of the rotating system, for example a strong polarisation rate and a strong circularity are probably due to the rotating shaft. Distinguishing this part of the signal, the complement being comparable to disturbances, can be useful for, for example, identifying said shaft (for the purposes of modelling) or, better, controlling it in the context of a shaft equipped with magnetic bearings.

Optionally, the at least one characterisation indicator is normalised, in other words, its value lies between −1 and 1 or between 0 and 1.

The characterisation indicator is given for a plane, it is then denoted A, or by comparison between two planes, it is then denoted I.

The characterisation indicator is qualified as criterion, denoted C, when it is constructed from any characteristic quantity re-evaluated at each instant t. The characterisation indicator is qualified as stationarity, denoted S, when it is based on the stationarity in time of a quantity (maximum when the variation in time of said quantity is zero).

Thus, the indicator of the polarisation rate is denoted:

$$∀ t ∈ {T}_{↓} , ∀ f ∈ {F}_{+} , {AC}_{polarisation} ( t , f ) = Φ ( t , f )$$

For a plane, the intensity indicator is:

$$∀ t ∈ {T}_{↓} , ∀ f ∈ {F}_{+} , {AC}_{intensity} ( t , f ) = {normalise}_{τ ∈ {T}_{↓} , v ∈ {F}_{+}} ( {S}_{0} ( t , f ) )$$

With the normalisation function:

$$∀ t ∈ TT , ∀ f ∈ FF , {normalise}_{τ ∈ TT , v ∈ FF} ( x ( t , f ) ) = \frac{x ( t , f )}{{max}_{τ ∈ TT , v ∈ FF}^{*} ( \vert x ( τ , v ) \vert )}$$

TT and FF designate sets of generic dates and frequencies, taking their value from the set of the real numbers R.

For a plane, the amplitude indicator is:

$$∀ t ∈ {T}_{↓} , ∀ f ∈ {F}_{+} , {AC}_{amplitude} ( t , f ) = {normalise}_{τ ∈ {T}_{↓} , v ∈ {F}_{+}} ( a ( t , f ) )$$

For a plane, the sign indicator is −1 or 1 depending on the sign of χ:

$$∀ t ∈ {T}_{↓} , ∀ f ∈ {F}_{+} , {AC}_{sign} ( t , f ) = sign ( χ ( t , f ) )$$

For a plane, the circularity indicator is:

$$∀ t ∈ {T}_{↓} , ∀ f ∈ {F}_{+} , {AC}_{circularity} ( t , f ) = \frac{\vert χ ( t , f ) \vert}{π / 4}$$

For a plane, the indicator of sign stationarity, in other words of direction of rotation, in other words of orientation, is:

$$∀ t ∈ {T}_{↓} , ∀ f ∈ {F}_{+} , {AS}_{sign} ( t , f ) = autostat ( {AC}_{sign} ( t , f ) , tol = 0 )$$

With the stationarity function:

$$∀ t ∈ TT , \begin{matrix}for tol > 0 : autostat ( x ( t ) , t o l ) = e \frac{\vert dx ( f ) \vert}{tol} \\ for tol = 0 : autostat ( x ( t ) , 0 ) = ( dx ( t ) == 0 )\end{matrix}$$

For a plane, the circularity stationarity indicator is:

$$∀ t ∈ {T}_{↓} , ∀ f ∈ {F}_{+} , {AS}_{circularity} ( t , f ) = autostat ( {AC}_{circularity} ( t , f ) , tol = 0.1 )$$

For a plane, the direction stationarity indicator, in other words the indicator of geometric inclination of the ellipse, is:

$$∀ t ∈ {T}_{↓} , ∀ f ∈ {F}_{+} , {AS}_{direction} ( t , f ) = autostat ( θ ( t , f ) , tol = 10. π / 180 )$$

For a plane, the synchronisation stationarity indicator is:

$$∀ t ∈ {T}_{↓} , ∀ f ∈ {F}_{+} , {AS}_{sunchro} ( t , f ) = autostat ( φ ( t , f ) , tol = 10. π / 180 )$$

For two planes, each parameter or indicator is redefined for an additional plane, by denoting these new parameters using an apostrophe, for example a′.

The comparative characterisation indicator of the amplitude is:

$$∀ t ∈ {T}_{↓} , ∀ f ∈ {F}_{+} , {IC}_{amplitude} ( t , f ) = {normalise}_{τ ∈ {T}_{↓} , v ∈ {F}_{+}} ( \sqrt{a ( t , f ) . {a}^{′} ( t , f )} )$$

The comparative characterisation indicator of the sign is a Boolean between 0 and 1 depending on the result of the following test:

$$∀ t ∈ {T}_{↓} , ∀ f ∈ {F}_{+} , {IC}_{sign} ( t , f ) = ( {AC}_{sign} ( t , f ) == {AC}_{sign}^{′} ( t , f )$$

The comparative characterisation indicator of circularity is:

$$∀ t ∈ {T}_{↓} , ∀ f ∈ {F}_{+} , {IC}_{circularity} ( t , f ) = 1 - reldif ( {AC}_{circularity} ( t , f ) , {AC}_{circularity}^{′} ( t , f ) )$$

With the relative error function such that:

$$reldif ( x , y ) = {ratio}^{*} ( 2. \vert x - y \vert , \vert x \vert + \vert y \vert )$$

And with the division function with exception such that:

$${ratio}^{*} ( x , y ) = \begin{matrix}x / y if y \neq 0 \\ 0 otherwise\end{matrix}$$

The comparative characterisation indicator of direction, in other words of geometric inclination of the ellipse, is:

$$∀ t ∈ {T}_{↓} , ∀ f ∈ {F}_{+} , {IC}_{direction} ( t , f ) = 1 - reldif ( θ ( t , f ) , {θ}^{′} ( t , f ) )$$

The comparative characterisation indicator of synchronisation is:

$$∀ t ∈ {T}_{↓} , ∀ f ∈ {F}_{+} , {IC}_{synchro} ( t , f ) = 1 - reldif ( φ ( t , f ) , {φ}^{′} ( t , f ) )$$

The characterisation indicator of stationarity and the comparative characterisation indicator of circularity is:

$$\begin{matrix}∀ t ∈ {T}_{↓} , ∀ f ∈ {F}_{+} , \\ {IS}_{circularity} ( t , f ) = autostat ( {AC}_{circularity} ( t , f ) - {AC}_{circularity}^{′} ( t , f ) , tol = 0.1 )\end{matrix}$$

The characterisation indicator of stationarity and the comparative characterisation indicator of direction is:

$$∀ t ∈ {T}_{↓} , ∀ f ∈ {F}_{+} , {IS}_{direction} ( t , f ) = autostat ( θ ( t , f ) - {θ}^{′} ( t , f ) , tol = 10. π / 180 )$$

The characterisation indicator of stationarity and the comparative characterisation indicator of synchronisation is:

$$∀ t ∈ {T}_{↓} , ∀ f ∈ {F}_{+} , {IS}_{synchro} ( t , f ) = autostat ( φ ( t , f ) - {φ}^{′} ( t , f ) , tol = 10. π / 180 )$$

Other indicators can be constructed from the quantities constructed in the steps 70 and 50.

Optionally, a step 90 of insertion of the at least one characterisation indicator into a neural network is performed in order to classify said indicator as a function of the rotation of the shaft and link it to a previously listed anomaly. The anomalies similar to the learning base are then detected.

Optionally, a step 100 is performed of displaying the at least one characterisation indicator extracted to be legible for an operator and allow him or her to understand potential anomalies of the rotating shaft.

A step 110 of displaying an image of the trajectory of at least one equivalent ellipse can also be performed.

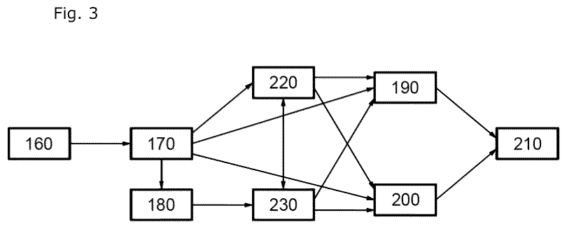

FIG. 3 schematically represents filtering steps according to a mode of implementation of the method according to the present disclosure. In a particular implementation, the following steps are performed following the step 80 of extraction of a characterisation indicator.

The filtering method is intended to filter at least one signal to be filtered, for example a signal determined from measurements representative of the movement of a rotating shaft. The method is performed in real-time or not. The signal can be one of the input signals determined in the step 10, and/or one of the components of the input signals determined in the step 20, and/or even the bivariate signal determined in the step 30.

In order to perform this filtering method, a step 120 is performed first for defining at least one characterisation indicator of the rotating shaft, the characterisation indicator being obtained from a frequency analysis of the behaviour of the rotating shaft.

In a particular mode of implementation, the characterisation indicator is an indicator extracted during the step 80 previously described.

Thus, the at least one characterisation indicator comprises the polarisation rate Ø previously described, and/or an indicator of circularity, and/or an indicator of intensity and/or an indicator of amplitude, and/or an indicator of direction of rotation, and/or an indicator of direction, and/or of orientation, and/or of synchronisation of the equivalent ellipse.

A step 130 is then performed for determining a filtering template as a function of the at least one characterisation indicator.

The step 130 of determination of a filtering template comprises, for example, a step of calculation 131 of a mask M, such that:

$$∀ t ∈ {T}_{↓} , ∀ f ∈ {F}_{+} , M ( t , f ) = {combine}_{i , j , k , l} ( {AC}_{{item}_{i}} ( t , f ) , {AS}_{{item}_{j}} ( t , f ) , {IC}_{{item}_{k}} ( t , f ) , {IS}_{{item}_{l}} ( t , f ) )$$

In which combine is a function which takes as input one or more characterisation indicators with values in [0,1] or [−1,1] and restores as output a real value in [0,1].

Following the step 131 of calculation of the mask M, a step 132 of calculation of the filtering template P and its dual P* is performed such that:

$$∀ t ∈ {T}_{↓} , ∀ f ∈ {F}_{+} , \begin{matrix}P ( t , f ) = M ( t , f ) . N ( t , f ) \\ {P}^{*} ( t , f ) = {M}^{*} ( t , f ) . N ( t , f )\end{matrix}$$

With N a frequency weighting with values in [0,1]. N is an arbitrary frequency weighting, independent of M and is like a conventional frequency filtering. N makes it possible for example to focus on a frequency band around the speed of the shaft.

And the dual mask, in other words the complement: M*=1−M

The benefit of considering M* and consequently P* is that, depending on the application, interest can be focused on a certain part of the signal, obtained according to the characterisation indicators used, given by M and/or on the remainder comparable to the disturbances given by M*. For example, it is possible to imagine a controller of magnetic bearings acting differently on the rotating part and on the external disturbances.

In one mode of implementation, the mask M, and by extension the filtering template P, is defined with respect to a predefined threshold of a characterisation indicator, for example a predefined threshold of a polarisation rate, and/or a circularity indicator of an equivalent ellipse as described previously. The constancy of a characterisation indicator makes it possible also to define a filtering template with respect to said characterisation indicator.

Finally, a step 140 is performed of application of the filtering template P to the signal to be filtered, for example a signal determined from the measurements representative of the movement of the rotating shaft.

In one mode of implementation, the filtering template is applied to the time-frequency breakdown of the bivariate signal so as to obtain a filtered bivariate signal R and its dual R* calculated jointly. The step 140 is then performed according to different modes of implementation.

By starting from the time-frequency breakdown by short-term single-sided Fourier transform, a step 141 of calculation of an intermediate filtered bivariate signal \grave{R}, of its dual \grave{R}*, and of the components of the filtered input signals determined in the step 20 Ùₓ, Ù*ₓ, Ù*_{y}, and Ù_{y}, is obtained.

$$∀ t ∈ {T}_{↓} , ∀ τ ∈ [ t - {dt}^{-} , t + {dt}^{+} ] , \begin{matrix}{{U}^{‵}}_{x} ( t , τ ) = 2. Re ( {\sum }_{f ∈ {F}_{+}} c ( f ) . P ( t , f ) . {\hat{s}}_{x} ( t , f ) . {e}^{1 i \text{.2} π . f . τ} ) \\ {{U}^{‵}}_{x} ( t , τ ) = 2. Re ( {\sum }_{f ∈ {F}_{+}} c ( f ) . P ( t , f ) . {\hat{s}}_{y} ( t , f ) . {e}^{1 i \text{.2} π . f . τ} ) \\ {{U}^{‵}}_{x}^{*} ( t , τ ) = 2. Re ( {\sum }_{f ∈ {F}_{+}} c ( f ) . {P}^{*} ( t , f ) . {\hat{s}}_{x} ( t , f ) . {e}^{1 i \text{.2} π . f . τ} ) \\ {{U}^{‵}}_{y}^{*} ( t , τ ) = 2. Re ( {\sum }_{f ∈ {F}_{+}} c ( f ) . {P}^{*} ( t , f ) . {\hat{s}}_{y} ( t , f ) . {e}^{1 i \text{.2} π . f . τ} )\end{matrix}$$

$$with : \begin{matrix}c ( 0 ) = 0.5 \\ \begin{matrix}∀ f \neq 0 , & c ( f ) = 1\end{matrix}\end{matrix}$$

$$and$$

$$∀ t ∈ {T}_{↓} , ∀ τ ∈ [ t - d {t}^{-} , t + d {t}^{+} ] , \begin{matrix}{R}^{‵} ( t , τ ) = {{U}^{‵}}_{x} ( t , τ ) + 1 i . {{U}^{‵}}_{y} ( t , τ ) \\ {{R}^{*}}^{‵} ( t , τ ) = {{U}^{‵}}_{x}^{*} ( t , τ ) + 1 i . {{U}^{‵}}_{y}^{*} ( t , τ )\end{matrix}$$

By starting from the time-frequency breakdown by short-term double-sided Fourier transform, a step 142 of calculation of the intermediate filtered bivariate signal \grave{R}, of its dual \grave{R}*, is obtained such that:

$$\begin{matrix}∀ t ∈ {T}_{↓} , ∀ τ ∈ [ t - d {t}^{-} , t + d {t}^{+} ] , {R}^{`} ( t , τ ) = P ( t , 0 ) . \tilde{s} ( t , 0 ) + {\sum }_{f ∈ {F}_{+}^{*}} ( P ( t , f ) . \tilde{s} ( t , f ) . {e}^{1 i \text{.2} π . f . τ} + P ( t , - f ) . \tilde{s} ( t , - f ) . {e}^{- 1 i \text{.2} π . f . τ} ) \\ {R}^{‵} ( t , τ ) = {P}^{*} ( t , 0 ) . \tilde{s} ( t , 0 ) + {\sum }_{f ∈ {F}_{+}^{*}} ( {P}^{*} ( t , f ) . \tilde{s} ( t , f ) . {e}^{1 i \text{.2} π . f . τ} + {P}^{*} ( t , - f ) . \tilde{s} ( t , - f ) . {e}^{- 1 i \text{.2} π . f . τ} )\end{matrix}$$

By starting from the time-frequency breakdown by short-term quaternion Fourier transform, a step 143 of calculation of the intermediate filtered bivariate signal \grave{R}, of its dual \grave{R}*, is obtained such that:

$$∀ t ∈ {T}_{↓} , ∀ τ ∈ [ t - d {t}^{-} , t + d {t}^{+} ] , \begin{matrix}{R}^{‵} ( t , τ ) = P r o {j}_{{⊂}_{1 i}} ( {\sum }_{f ∈ {F}_{+}} P ( t , f ) {.}_{S}^{o} ( t , f ) . {e}^{1 j \text{.2} π . f . τ} ) \\ {{R}^{*}}^{‵} ( t , τ ) = P r o {j}_{{⊂}_{1 i}} ( {\sum }_{f ∈ {F}_{+}} {P}^{*} ( t , f ) {.}_{S}^{o} ( t , f ) . {e}^{1 j \text{.2} π . f . τ} )\end{matrix}$$

Finally, the following equality 144 makes it possible to determine the filtered bivariate signal R and its dual R* by reconstituting the complete time axis by pieces:

$$∀ t ∈ {T}_{↓} , \begin{matrix}R ( [ t - d {t}^{-} , t + d {t}^{+} ] ) = {R}^{‵} ( t , [ t - d {t}^{-} , t + d {t}^{+} ] ) \\ {R}^{*} ( [ t - d {t}^{-} , t + d {t}^{+} ] ) = {{R}^{*}}^{‵} ( t , [ t - d {t}^{-} , t + d {t}^{+} ] )\end{matrix}$$

Optionally, a step 150 of obtaining filtered input signals U₁ to U_{M}, by projection of the filtered bivariate signal R onto the axes collinear to the measured quantities, is performed.

The filtering template thus makes it possible to select specific ranges of frequencies on the input signals.

In a particular mode of implementation, several filtering templates are applied successively and/or in combination. Furthermore, the filtering method can be applied to measurements performed in different planes or for different quantities.

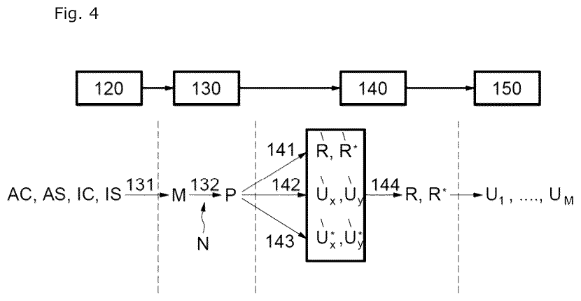

FIG. 4 represents the different steps of the method for controlling the rotating shaft according to the present disclosure.

For the implementation of the present control method, a step 160 is performed first of acquisition of a signal to be filtered determined on the basis of measurements representative of the movement of the rotating shaft, the measurements being non-collinear with one another and, optionally, coplanar with a plane secant to the axis of rotation of the rotating shaft.

In a particular mode of implementation, the step 160 of acquisition of a signal to be filtered is performed by the implementation of the steps 10, 20 and 30 described previously. During these steps 10, 20 and 30, input signals are acquired which are finally merged into a bivariate signal forming said signal to be filtered.

A step 170 of filtering and breakdown of the signal to be filtered into a stationary component and a disturbance component is then performed for each time-frequency pairing of the signal to be filtered.

In a particular mode of implementation, the step 170 of filtering and breakdown of the signal to be filtered is performed by the implementation of the steps 40, 50 and 80 described previously, and optionally by the implementation of the steps 60 and 70 described previously, then by the implementation of the steps 120 to 140. During these steps 40, 50, 80, 120, 130 and 140, a step 40 of time-frequency breakdown of the bivariate signal into spectral elements for which an equivalent ellipse is then determined (step 50) is performed and a characterisation indicator of the rotating shaft is extracted (step 80).

The characterisation indicator extracted and defined during the step 120 is preferentially of stationary type, in other words an indicator of AS or IS type, for example the circularity indicator AC_{circularity}. During the step 130, a filtering template is therefore determined as a function of the at least one stationarity characterisation indicator.

Finally, during the step 140, said filtering template is applied to the signal to be filtered, namely, for example, the bivariate signal r(t).

The filtered signal thus comprises a stationary component whose nature depends directly on the characterisation indicator defined. A stationary component is for example an equivalent ellipse of constant polarisation, for example circular. The stationary component subtracted from the signal to be filtered gives a so-called disturbance component, complementing the stationary component, in other words the dual of the stationary component.

Thus, by applying the filtering template to the time-frequency breakdown of the bivariate signal, a stationary component and a disturbance component are obtained for each time and frequency of the signal to be filtered.

Optionally, the filtering and breakdown step 170 comprises a step 180 of generation of stationarity break information, the stationarity break being understood to be a rapid variation of the stationarity.

Next, a step of comparison 190 of the stationary component with respect to a setpoint is performed. In parallel, a step of comparison 200 of the disturbance component with respect to said setpoint is performed. The comparison steps 190 and 200 respectively comprise the generation of a stationarity command and a disturbance command.

Finally, a step 210 of generation of a command of an actuator associated with the rotating shaft is performed, the command being generated from the comparisons of the stationary and disturbance components, in other words from the stationarity and disturbance commands, such that the actuator modifies a rotation and/or positioning parameter of the rotating shaft. The inclination or the positioning according to a particular axis of the shaft can thus be modified so as to reduce the defects and/or deformations measured and characterised during the step 160. An actuator is understood to be an assembly of at least one actuator.

The steps 190, 200 are for example performed by at least one corrector, such as a PID corrector, as a function of the deviation between the stationary component and the setpoint, and the deviation between the disturbance component and the setpoint, the corrector being configured to generate a command reducing these deviations. The steps 190 and 200 can advantageously be performed by more specialised controllers, for example the step 190 comprises a corrector of PID type and the step 200 comprises a sliding mode corrector, which is conventionally more effective for disturbances of strong amplitudes and that are non-linear. The command generated during the step 210 is a combination of the stationarity and disturbance commands, for example the sum of the stationarity command and of the disturbance command.

The rotating shaft is for example a magnetic bearing, the position of which is servocontrolled by virtue of at least one actuator, for example an electromagnet.

In a particular mode of implementation, the method further comprises a step 220 of identification of a model from the stationary component. The identified model is for example a frequency model, in other words in transfer function form, and/or parametric, in other words established in the form of a parametric equation, a frequency model being able to be established in order to determine a parametric model.

Advantageously, the steps 190 and 200 of comparison of the stationary and disturbance components with a setpoint are performed with the model identified during the identification step 220 taken into account. For example, the model makes it possible to perform a control that is adaptive or with internal model.

In particular, the next step 210 of generation of a command of an actuator is performed so as to minimise a difference between the identified model and the stationary and disturbance components.

In a particular mode of implementation, the method further comprises a step 230 of monitoring the stationarity break information generated in the step 180. The monitoring step 230 also comprises the generation of an alert signal when a stationarity break is detected.

This monitoring step 230 can be performed with the model identified in the identification step 220 taken into account so as to interpret the stationarity breaks detected. For example, an identified model can predict a stationarity break at a certain time t, for example in the case of a change of operating point. If a stationarity break is not detected or is detected at another time t′, an alert signal can be generated, the stationarity break being abnormal. Conversely, the identification step 220 can be performed with a stationarity break detected during the monitoring step 230 taken into account.

Advantageously, the steps 190 and 200 of comparison of the stationary and disturbance components are performed with the alert signal generated during the monitoring step 230 taken into account.

In a particular mode of implementation of the steps 190 and 200, the stationarity command and the disturbance command generated each comprise an additional injection signal. The injection signal takes the form of a sinusoid of the lowest possible amplitude so as not to destabilise the rotating shaft, but the excitation effects of which on the rotating shaft remain measurable in the step 10 of acquisition of the input signals. The frequency of the sinusoid can be modified in order to explore all the operating frequency ranges of the rotating shaft. The step 10 of acquisition of the input signals then makes it possible to obtain the response to the injection signal and the associated transfer function during the step 220 of identification of a model.

Optionally, the injection signal is added to the command of an actuator generated in the step 210, this loopback taking on an informational nature that can act on certain weightings of the stationarity and disturbance commands.

In a particular mode of implementation, all the steps of the method are implemented by computer, with the possibility of real-time execution, notably in a magnetic bearing control enclosure.

Certain terms and functions used in the calculations previously detailed are redefined hereinbelow:

The set of the strictly positive frequencies is: F*₊={fⱼ, j=[1, n]}

The set of the strictly negative frequencies is: F*₋=−F₊

Also defined is: F₊={0}∪F*₊

Also defined is: F₋=F*₋∪{0}

The complete set of the frequencies is: F=F₋∪F₊=F*₋∪{0}∪F*₊

The generic stationarity function is:

$$∀ t ∈ TT , \begin{matrix}for tol > 0 : autostat ( x ( t ) , tol ) = {e}^{- \frac{\vert dx ( t ) \vert}{tol}} \\ for tol = 0 : autostat ( x ( t ) , 0 ) = ( dx ( t ) == 0 )\end{matrix}$$

The maximum function with exception is:

$${max}^{*} ( x ) = \begin{matrix}max ( x ) if max ( x ) \neq 0 \\ 1 otherwise\end{matrix}$$

The normalisation function is:

$$∀ t ∈ T T , ∀ f ∈ FF , {normalise}_{τ ∈ TT , v ∈ FF} ( x ( t , f ) ) = \frac{x ( t , f )}{{max}_{τ ∈ TT , v ∈ FF}^{*} ( \vert x ( τ , v ) \vert )}$$

The division function with exception is:

$${ratio}^{*} ( x , y ) = \begin{matrix}x / y if y \neq 0 \\ 0 otherwise\end{matrix}$$

The relative error function is:

$$reIdif ( x , y ) = {ratio}^{*} ( 2. \vert x - y \vert , \vert x \vert + \vert y \vert )$$

Remember also the definition of the arctan 2 function, a formulation equivalent to the argument of the complex number x+1μ·γ:

$$Arg ( x + 1 μ . y ) = arctan 2 ( y , x )$$

What is claimed is:

1. A method for controlling a rotating shaft by an actuator comprising the following steps:
acquisition of a signal to be filtered determined from measurements representative of the movement of the rotating shaft, the measurements being non-collinear with one another;
filtering and breakdown of the signal to be filtered into a stationary component and a disturbance component for each time-frequency pairing of the signal to be filtered;
comparison of the stationary component with respect to a setpoint for each time-frequency pairing;
comparison of the disturbance component with respect to said setpoint for each time-frequency pairing; and
generation of a command of an actuator associated with said shaft based on the two comparisons of the stationary and disturbance components, such that the actuator modifies a rotation and/or positioning parameter of the rotating shaft.

2. The method according to claim 1, further comprising a step of identification of a model from the stationary component, the identified model being a frequency and/or parametric model.

3. The method according to claim 2, wherein the steps of comparison of the stationary and disturbance components are performed with the model identified during the identification step taken into account.

4. The method according to claim 3, wherein the step of generation of a command of an actuator is performed so as to minimise a difference between the identified model and the stationary and disturbance components.

5. The method according to claim 1, wherein the filtering and breakdown step comprises a step of generation of stationarity break information.

6. The method according to claim 5, further comprising a step of monitoring the stationarity break information and of generation generating an alert signal when a stationarity break is detected.

7. The method according to claim 6, further comprising a step of identification of a model from the stationary component, the identified model being a frequency and/or parametric model, and wherein the monitoring step is performed with the model identified during the identification step taken into account so as to interpret the stationarity breaks detected.

8. The method according to claim 6, wherein the steps of comparison of the stationary and disturbance components are performed with the alert signal generated during the monitoring step taken into account.

9. The method according to claim 1, wherein the filtering step is performed by application of a filtering template to the signal to be filtered, the filtering template being determined as a function of a characterisation indicator obtained from the following steps:
acquisition over a predetermined period of at least two input signals, the input signals comprising measurements representative of the movement of the rotating shaft, the measurements being non-collinear with one another;
determination of two components of the input signals, the components being orthogonal to one another;
merging of the two components into a bivariate signal forming said signal to be filtered;
time-frequency breakdown of the bivariate signal into spectral elements;
determination of an equivalent ellipse for each spectral element; and
extraction of the characterisation indicator of the rotating shaft based on parameters of the equivalent ellipse.

10. The method according to claim 9, wherein the filtering template is applied to the time-frequency breakdown of the bivariate signal as signal to be filtered so as to obtain the stationary component, the complement of the stationary component being the disturbance component.

11. The method according to claim 4, wherein the filtering and breakdown step comprises a step of generation of stationarity break information.

12. The method according to claim 11, further comprising a step of monitoring the stationarity break information and of generation generating an alert signal when a stationarity break is detected.

13. The method according to claim 12, wherein the monitoring step is performed with the model identified during the identification step taken into account so as to interpret the stationarity breaks detected.

14. The method according to claim 13, wherein the steps of comparison of the stationary and disturbance components are performed with the alert signal generated during the monitoring step taken into account.

15. The method according to claim 14, wherein the filtering step is performed by application of a filtering template to the signal to be filtered, the filtering template being determined as a function of a characterisation indicator obtained from the following steps:
acquisition over a predetermined period of at least two input signals, the input signals comprising measurements representative of the movement of the rotating shaft, the measurements being non-collinear with one another;
determination of two components of the input signals, the components being orthogonal to one another;
merging of the two components into a bivariate signal forming said signal to be filtered;
time-frequency breakdown of the bivariate signal into spectral elements;
determination of an equivalent ellipse for each spectral element; and
extraction of the characterisation indicator of the rotating shaft based on parameters of the equivalent ellipse.

16. The method according to claim 15, wherein the filtering template is applied to the time-frequency breakdown of the bivariate signal as signal to be filtered so as to obtain the stationary component, the complement of the stationary component being the disturbance component.
